(19) United States
(12) Patent Application Publication
(10) Pub. No.: US 2017/0208926 A1
(43) Pub. Date: Jul. 27, 2017

(54) CONNECTION ADAPTER

(71) Applicant: Wolfgang-Peter GELLER, Garlstorf (DE)

(72) Inventor: Wolfgang-Peter GELLER, Garlstorf (DE)

(21) Appl. No.: 15/415,005

(22) Filed: Jan. 25, 2017

(30) Foreign Application Priority Data
Jan. 27, 2016 (DE) 20 2016 100 364.4

(51) Int. Cl. A45F 3/14; G02B 23/16

(52) U.S. Cl. CPC A45F 3/14; G02B 23/16; A45F 2003/142

(57) ABSTRACT

A connection adapter for connecting a carrying strap to binoculars. The adapter includes an adapter body having a first connecting portion in which a tripod screw for connection to a tripod bush is arranged rotatably relative to the adapter body and oriented with a screw thread axis along a first direction. The adapter body also includes a second connecting portion that connects to a connection piece on the carrying strap. The first and second connecting portions are offset relative to one another in a direction perpendicular to the screw thread axis by a first spacing and in a direction parallel to the screw thread axis by a second spacing. The second connecting portion has a thread for receiving a tripod screw, formed with a thread axis extending parallel to the screw thread axis or inclined relative thereto by a maximum of 20° or has a coupling element.

### BACKGROUND OF THE INVENTION

Technical Field

The invention relates to a connection adapter for connecting a carrying strap to binoculars, with an adapter body, which has a first connecting portion, in which a tripod screw for connection to a tripod bush is arranged rotatably relative to the adapter body and oriented with a screw thread axis along a first direction, and a second connecting portion with means for connection to a connection piece arranged on the carrying strap, wherein the connecting portions are offset relative to one another in a direction perpendicular to the screw thread axis by a first spacing and in a direction parallel to the screw thread axis by a second spacing.

Background Information

Binoculars are often carried by their users on walks or when they head into the outdoors, for example, for observation of birds or when hunting. Because the binoculars are not held in the hands at all times or even required in such situations, they are hung from carrying straps around the neck. For this purpose, binoculars have appropriate connections at the sides on the spotting scopes, typically eyelets, to each of which an end of the carrying strap is fixed. This method of carrying binoculars is a well-established solution. Corresponding references in the prior art can be found for example in DE 6750210 U and in DE 8234999 U1. This manner of carrying binoculars by means of a carrying strap fixed by means of an end to two sides of the binoculars, which is simply carried around the neck in a conventional manner, is the most common method of carrying binoculars today. This method continues to be relied upon, and attempts are being made only to make improvements to the attachment of the carrying strap to the two side positions of the binoculars, for example, according to DE 20 2015 003 640 U1.

For cameras, which were originally also mainly carried only around the neck on carrying straps fixed by means of two ends to each side of the camera housing on eyelets provided thereon, a new carrying concept was proposed several years ago, which provides for a carrying strap which is to be worn crosswise over the torso and which is formed as a closed loop, which carrying strap is provided with a connection piece which is able to be displaced in a sliding manner over the strap, by means of which the carrying strap can be connected to the tripod screw bush in the camera housing or in a lens connected to the camera. This concept is described in WO 2008/131135 A1. Such carrying straps have also been commercially available since approximately 2007. As described in WO 2008/131135 A1, there are very different options for connecting the connection piece of the carrying strap to the tripod screw bush on the camera housing. For this purpose, it is for example possible to provide on the carrying strap a tripod screw attached in a displaceable manner directly along the longitudinal direction thereof, as is depicted for example in FIG. 7 of said publication. However, solutions are also described here in which a separate connection part of a tripod screw with a holding eyelet fixed thereon is screwed into the tripod screw bush in the camera housing, which connection part can then be connected to the spring hook and thus to the carrying strap by means of a spring hook, which is attached to the carrying strap and coupled with the eyelet. Such an example is depicted in FIG. 18 of the publication. A variety of different connection pieces have now been proposed for such carrying strap systems, such as that described in DE 20 2012 104 214 U1, for example. However, these carrying strap systems have until now only dealt with making it easier to carry film or photographic equipment, as yet there have been no attempts to also transfer to binoculars this basic means for carrying heavy items—which are to be held in front of the face during use—on a strap guided in a loop crosswise over the torso.

Binoculars often also have a tripod bush which is standard for tripod screws, which is usually arranged on the front side in a central axis intercept, on which the two lens tubes, which together form the binoculars, are arranged rotatable relative to one another. This tripod screw bush is provided to allow connection of the binoculars by means of an appropriate adapter piece to a conventional tripod used for photographic cameras or film-making equipment, for example a three-legged tripod. To do this, a special adapter piece is provided, which has a tripod screw bush in a first connecting portion, which tripod screw bush is guided in a first thread longitudinal direction and which has a second connecting portion with a tripod screw, the thread longitudinal axis of which lies substantially perpendicular to the thread longitudinal direction of the tripod screw bush. This adapter piece can be screwed onto the tripod plate of a conventional tripod and then connected to the binoculars. This option is often used to obtain a precise orientation of the visual field of the binoculars towards an area to be viewed and also so as not to have to always tiresomely hold the binoculars in the hands for a long viewing period. Birdwatchers, for example, use this type of fixation of binoculars to a tripod. Such an adapter piece is described for example in JP 2002072104 A. Such an adapter piece is however suitable only for the fixation of binoculars to a conventional tripod, and in particular cannot be applied and used in a different way due to the above-described and particular orientation of said axes (of the thread longitudinal direction of the tripod screw and of the thread longitudinal axis).

Given the prior art and in particular the knowledge of the existing advantages associated with the transport and carrying of photographic equipment and film cameras by means of a carrying system, as in WO 2008/131135 A1, the inventor has now considered whether or not it might not also be possible to take advantage of such advantages not only with respect to cameras, but also for binoculars which need to be carried, which, dependent on magnification and luminosity, can also have a not insignificant weight and the carrying of which in a standard manner with a neck strap can be correspondingly tiresome and uncomfortable over a long period.

### SUMMARY

As a result of such reflection, the inventor has developed a novel connection adapter, the special design of which permits the connection of a carrying strap as described in WO 2008/131135 A1 to binoculars and to the tripod threaded bush of the binoculars thereon. Such a connection adapter includes the special features of an adapter body that has a first connecting portion in which a tripod screw for connection to a tripod bush is arranged rotatably relative to the adapter body and oriented with a screw thread axis along a first direction, and a second connecting portion with means for connection to a connection piece arranged on the carrying strap. The connecting portions are offset relative to one another in a direction perpendicular to the screw thread axis by a first spacing and in a direction parallel to the screw thread axis by a second spacing. Furthermore, the second connecting portion has an internal thread for receiving a tripod screw formed with a thread axis extending parallel to the screw thread axis or inclined relative thereto by a maximum of 20° , or the second connecting portion has a coupling element. Advantageous further developments thereof include that the adapter body is formed from at least two partial bodies, a first one of which carries the first connecting portion and a second of which carries the second connecting portion; wherein the two partial bodies can be connected to one another in at least two different positions in order to thus be able to variably adjust at least one of the first spacing or the second spacing, The first spacing is 5 mm to 100 mm and the second spacing is 10 mm to 500 mm. The adapter body is formed entirely integral. Furthermore the first connecting portion is arranged in a first flat plateau region and that the second connecting portion is arranged in a second flat plateau region, wherein the plateau regions are oriented substantially parallel to one another in their respective flat extension. A surface of the adapter body between the first and the second connecting portion has a course which is curved in an S shape in one cross section. The adapter body may also be formed band-shaped flat. The adapter body may be formed from a plastic or from a metal. Additionally, the tripod screw in the first connecting portion is undetachably fixed to the adapter body. In the instance where the second connecting portion has an internal thread for receiving a tripod screw formed with a thread axis extending parallel to the screw thread axis or inclined relative thereto by a maximum of 20°, then the internal thread in the second connecting portion is formed passing through this second connecting portion in such a way that a tripod screw can be screwed into this internal thread from both open sides thereof. Alternatively, in the instance where the second connecting portion has a coupling element, then that coupling element is an eyelet.

According to the invention, a connection adapter for connecting a carrying strap to binoculars thus has an adapter body. This adapter body has a first and a second connecting portion. In the first connecting portion, a tripod screw for connection to a tripod threaded bush of the binoculars is arranged rotatably relative to the adapter body and oriented with a screw thread axis along a first direction. The second connecting portion has means for connecting to a connection piece arranged on the carrying strap. The connecting portions are offset relative to one another in a direction perpendicular to the screw thread axis by a first spacing and in a direction parallel to the screw thread axis by a second spacing. This connection adapter is now distinguished by a special design of the second connecting portion, with two alternatives being specified and being possible here. According to the invention, the second connecting portion can thus on the one hand have an internal thread for receiving a tripod screw formed with a thread axis extending parallel to the screw thread axis or inclined relative thereto by a maximum of 45°, preferably by a maximum of 20°, usually up to a maximum of 15°. Alternatively, the second connecting portion can also [have] a coupling element for detachable connection to a corresponding companion piece on a connection piece of a carrying strap. Such a coupling element can be in the form of an eyelet, for example, with an eyelet generally being formed by a completely enclosed aperture, in other words, also being able to be realized for example by means of a bore or feedthrough in the adapter body. However, snap connectors, ball couplers and the like are also conceivable; there are no restrictions on the type of coupling.

The two alternatives mentioned serve the same purpose, namely, the formation of a means for attachment of binoculars to a carrying strap according to the strap type disclosed in WO 2008/131135 A1, and arise solely from the different designs of the connection piece of the carrying strap disclosed therein. If said carrying strap has a tripod screw firmly connected to the strap as the connection piece, then the second connecting portion must, in accordance with the above first-mentioned alternative, have an internal thread for receiving this tripod screw. If, however, the connection piece on the carrying strap has a different companion piece for connection to a coupling element, then such a coupling element can simply be arranged in the second connecting portion. If the connection piece thus has, e.g., a spring hook or a similarly formed connection element for detachable connection to an eyelet, then the coupling element in the second connecting portion can be formed as an eyelet. The coupling element can in particular be connected firmly and even integrally to the adapter body. Naturally the second connecting portion can however also be provided with the internal thread, into which a special tripod screw as depicted in WO 2008/131135 A1 can then be screwed, which tripod screw has a coupling element, e.g. an eyelet for the connection to a carabiner or the like on the connection piece of the carrying strap.

If a thread is provided in the second connecting portion, the orientation of its thread axis is particularly important. Because it is very important for the comfortable carrying of the binoculars on a carrying strap of the sort depicted and disclosed in WO 2008/131135 A1, that the binoculars hang with an orientation of the lens tubes as far as possible parallel to the body's longitudinal axis along the body, if appropriate, slightly tilted. To this end, the connection adapter cannot be formed in a manner as for the adapters known for a fixation of binoculars to tripods, with the screw axes or thread axes formed perpendicular to one another. Rather, a parallel or approximately parallel orientation (variations of a maximum of 45° can be tolerated) is to be preferred here. As a general rule, the smaller the variation from parallelism, the better is the performance. In this respect, a variation of a maximum of 20°, in particular of a maximum of 15° , in particular of a maximum of 10° , still more preferably of a maximum of 5°—depending on the type of binoculars to be connected, is particularly preferred.

In addition, the binoculars must be connected to the carrying strap at an attachment point arranged as close as possible to their center of gravity, advantageously at an attachment point arranged somewhat offset to the center of gravity (lying above said center of gravity in the carrying position of the binoculars), which is fixed to said carrying strap. Otherwise, a tilting moment would be permanently formed, so that the binoculars attached to the strap, which then hang down to the side of the body of the wearer, due to a corresponding tilting, press against the body, in particular the hips or the upper leg area, or bump against said areas when the wearer is walking. In order to achieve such a positioning of the attachment point close to the center of gravity, in other words, ultimately of the second connecting portion, the first spacing and the second spacing of the offset between the first and second connecting portions must be selected accordingly.

In the case of a coupling element formed in the second connecting portion, such as an eyelet, for example, its orientation is not of such great importance, because in conjunction with a connection piece having a companion piece, e.g., a spring hook or a similar detachable fastening element, a very flexible connection can be created here, which permits an orientation in an optimal geometric position relative to one another solely as a result of the weight of the binoculars. Nevertheless, when determining the orientation of the coupling element, it is naturally possible to take into account considerations with regards to an optimal position for the displacement of the attachment point as close as possible towards the center of gravity of the binoculars and for a suspension of the binoculars with the longitudinal axis thereof substantially parallel to the body's longitudinal direction, in order to obtain a well-balanced and intrinsically stable and positionally-accurate position of the binoculars fixed to the carrying strap by means of the adapter.

If the binoculars are now fixed by means of the adapter according to the invention to the carrying strap to be worn crosswise over the torso of the sort described in WO 2008/131135 A1, then the binoculars can be very quickly picked up from a carrying position at the side in the area of the hips of the user, guided with the help of the connection piece, which is displaceable on the carrying strap, along the carrying strap obliquely upwards and brought up to the face in order to then view an object magnified through the binoculars. If the user now wishes to continue on his way, he allows the binoculars to slide back down and guides them back into the carrying position at the side of the body. In this position, carrying the binoculars is very comfortable even when they are of a discernible weight and when this carrying takes place over long periods. In order to minimize a backwards and forwards movement of the binoculars when walking, an additional locking mechanism can also be provided here, for example on the user's belt. The connection of the binoculars and the fixation thereof to the special carrying strap are permitted only by means of the connection adapter according to the invention which is specially designed as described above.

Because the threaded bush formed in the manner described on the binoculars on a front side of the central axis part is not currently arranged lying in the area of the center of gravity of the binoculars, as already mentioned, the offset of the connecting portions in the said directions, namely one perpendicular to the screw thread axis of the tripod screw in the first connecting portion and one parallel thereto, is of particular importance. As has already been explained, by means of the selection of these spacings, the attachment point lying in the second connecting portion, at which the carrying strap is connected to the binoculars, is brought as close as possible to the center of gravity of the binoculars. The dimensions of these offset spacings are to be selected accordingly in a manner adapted to a respective binoculars model. The first spacing measurement can have values between 5 mm and 100 mm, and the second spacing measurement can have values between 10 mm and 500 mm. As explained, the precise selection of values for said spacings depends on the geometry of the specific binoculars which are to be fixed to the carrying strap. The first spacing is substantially determined by a spacing of the thread axis of the tripod screw threaded bush arranged in the binoculars from a plane, along which the adapter body can be guided, without colliding with other parts of the binoculars, such as an adjustment wheel for the focusing, for example. As a general rule, it shall be sought to bring the adapter body as close as possible to the binoculars in the longitudinal direction thereof in order to thus create an attachment point close to the center of gravity of the binoculars. The value for the second spacing then depends in particular on the installation length of the binoculars.

The connection adapter can generally be formed entirely integral with an adapter body. It can however also be formed from at least two partial bodies, a first one of which carries the first connecting portion and a second of which carries the second connecting portion. The two partial bodies can then be connected to one another in at least two different positions in order to thus be able to variably adjust at least one of the spacings, first spacing or second spacing, but preferably the second spacing. It is thus possible to obtain a universal connection adapter, which can be adapted to different binocular types and with which, by means of appropriate adjustment of the relative positions of the two partial bodies relative to one another, the second connecting portion can be brought as close as possible to the center of gravity of the respective binoculars. In principle, the provision of differently shaped first partial bodies and/or differently shaped second partial bodies is also conceivable, which can then optionally be brought together and connected to form an adapter body adapted to the specific binoculars to be fixed.

However, if the adapter body is formed in one piece, in order to cater to a market with differently shaped binoculars, several connection adapters which are differently dimensioned with regards to the spacings, first spacing and/or second spacing, are offered, so that a user can choose a connection adapter suited to his binoculars.

According to an advantageous further development of the invention, it is possible to provide in a connection adapter according to the invention that the first connecting portion is arranged in a first flat plateau region and that the second connecting portion is arranged in a second flat plateau region, wherein the plateau regions are oriented substantially parallel to one another in their respective flat extension. This is particularly advantageous when the second connecting portion has the internal thread because the plateau regions can then form bearing surfaces for the abutment around the tripod threaded bush in the binoculars and for a tripod threaded screw which is screwed into the internal thread in the second connecting portion. If a tilting of the binoculars fixed with the connection adapter to a carrying strap and carried at the side of the body is intentionally sought, for example in order to ensure that the binoculars remain close to the wearer's body with an end lying at the bottom in the carrying position, it is also possible to use here a specifically selected angular offset compared with an exact parallelism of the plateaus. The above described design can be advantageous not only for a design with a tripod threaded screw to be screwed into the second connecting portion, but also when a coupling element, e.g., an eyelet, is formed in the region of the second connecting portion.

In order to form the offset formed by the first spacing and the second spacing between the first connecting portion and the second connecting portion, the surface of the adapter body between the first and the second connecting portion can in particular have a course which is curved in an S shape in one cross section. In principle, however, other shapes are also conceivable, with the S-shaped course being preferred however from a production perspective, for aesthetic reasons and also with regards to a force transmission.

The connection adapter according to the invention can in particular have a band-shaped flat formed adapter body. Such an adapter body is comparatively light, and can be produced with reduced material usage and thus cost-effectively. It is equally possible, however, to select a compact, voluminous construction. This may be required, for example, taking into account considerations regarding the necessary stability of the connection adapter or its adapter body.

As material for the adapter body, in particular plastic, but also metal, can be considered. However, other materials can also be used, such as wood, for example.

It can also be provided that the tripod screw is undetachably fixed to the first connecting portion on the adapter body. This can be achieved, for example, by the tripod screw being fed through a corresponding bore in the first connecting portion and, on the other side, a retaining element is placed on the tripod screw, which retaining element projects across the diameter of the bore. This retaining element can be a rubber ring for example, which simultaneously also serves to exert a clamping force directed opposite to the screwing direction, so that the threaded screw in the threaded bush of the binoculars is screwed down securely and tightly and cannot be accidently detached. In this context, “undetachably” does not mean, for example, that the tripod screw cannot be detached from the first connecting portion by application of sufficient force. Instead, “undetachably” simply means in this context that the tripod screw remains fixed to the first connecting portion during normal usage and cannot detach therefrom.

In the case of a connection adapter according to the invention, when said connection adapter is formed with the internal thread in the second connecting portion it can be advantageous for this internal thread to run the full depth of the second connecting portion and to thus be freely accessible from both sides, so that a tripod screw can be screwed into this internal thread from both sides, in other words, from either one of the sides. The screwing direction shall be in the one direction in the manner of a right-hand thread and in the other direction in the manner of a left-hand thread. In this way, the user can decide from which side he wishes to contact the connection adapter. He can thus in particular determine the direction in which the binoculars hang in the carrying position. If the binoculars hang with the eyepiece side downwards, or if he wants a suspension of the binoculars with the lens side downwards, he must simply screw the tripod screw into the internal thread of the second connecting portion from the appropriate side.

As has emerged from the above statements and descriptions, with a connection adapter formed according to the invention, for the purpose of wearing and carrying binoculars, it is also possible to resort back to carrying straps and carrying strap systems of the sort described in WO 2008/131135 A1 which have proven to be effective for the carrying of cameras. In particular, by means of the connection adapters formed according to the invention, owners of such carrying straps, who have obtained them for carrying cameras, can also use these already owned carrying straps for carrying binoculars, in other words, in an additional functional area.

### BRIEF DESCRIPTION OF THE SEVERAL VIEWS OF THE DRAWINGS

Additional advantages and features of the invention will emerge from the following description of exemplary embodiments, with the figures showing:

FIG. 1 a first exemplary embodiment of a connection adapter according to the invention in a three-dimensional view from the side;

FIG. 2 a side view of the connection adapter according to FIG. 1;

FIG. 3 the connection adapter of the exemplary embodiment depicted in FIGS. 1 and 2, said connection adapter being fixed to binoculars;

FIG. 4 the binoculars with the connection adapter according to FIG. 3 fixed thereto, said binoculars being fixed to a carrying strap to be worn crosswise over the torso and lying in a transport position;

FIG. 5a a side view of a second exemplary embodiment of a connection adapter according to the invention;

FIG. 5b a front view of the second exemplary embodiment of a connection adapter according to the invention;

FIG. 5c a rear view of the second exemplary embodiment of a connection adapter according to the invention;

FIG. 6 binoculars with a connection adapter according to FIG. 5a to FIG. 5c fixed thereto, said binoculars being fixed to a carrying strap to be worn crosswise over the torso and lying in a transport position;

FIG. 7 in a side view, a third exemplary embodiment of a connection adapter according to the invention in a design comparable with the first exemplary embodiment depicted in FIG. 1, but with a two-part and variably adjustable adapter body;

FIG. 8 in a side view, the connection adapter according to FIG. 7 with an adapter body formed in a different positioning of the partial bodies;

FIG. 9a a perspective view of a third exemplary embodiment of the connection adapter according to the invention fixed to binoculars and with the adapter body shown in a first adjustment position;

FIG. 9b a perspective view of the third exemplary embodiment of the connection adapter according to the invention fixed to binoculars and with the adapter body shown in a second adjustment position;

FIG. 10a a rear view of a fourth exemplary embodiment of a connection adapter according to the invention in a design comparable with the second exemplary embodiment depicted in FIG. 5, but with a two-part and variably adjustable adapter body;

FIG. 10b a front view of the fourth exemplary embodiment of the connection adapter shown in FIG. 10a; and

FIG. 10c a side view of the fourth exemplary embodiment of the connection adapter shown in FIG. 10a.

### DETAILED DESCRIPTION

The figures depict a total of four possible exemplary embodiments of the invention in a schematic manner and in no way drawn to scale. These exemplary embodiments, which are described below with reference to the figures, serve to further explain the invention, with the possible configuration variants not being limited to the depicted exemplary embodiments. A person skilled in the art will naturally be aware of additional possible embodiment variants, which he will be able to identify in light of the general description of the full scope of the invention.

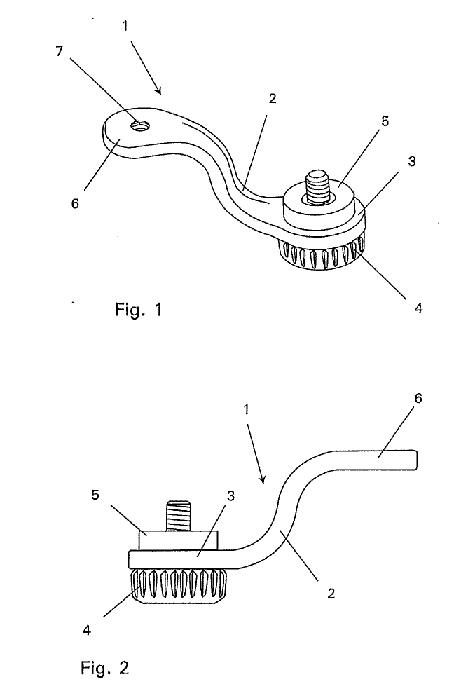

A first exemplary embodiment of a connection adapter according to the invention is depicted in FIGS. 1 to 4. The connection adapter depicted there is identified with the reference numeral 1. It has an adapter body 2, which is formed plate-shaped flat and presents an S-shaped course in a longitudinal section. A first connecting portion 3 is formed on the adapter body 2, which connecting portion is formed flat and plateau-shaped. In this connecting portion 3, a tripod screw 4 penetrates a bore introduced into the adapter body 2 and is undetachably secured on the adapter body 2 by means of a rubber washer 5 pushed onto the tripod screw 4. A second connecting portion 6 is formed on one longitudinal end of the adapter body 2 opposite the first connecting portion 3. This connecting portion is also formed plateau-shaped flat, with the planar courses of the respective plateaus of the connecting portions 3 and 6 being oriented substantially parallel relative to one another.

As can be seen in particular in FIG. 1, an internal thread 7 is incorporated into the connecting portion 6. This internal thread 7 is formed in a bore which passes all the way through the adapter body 2 in the second connecting portion 6. This internal thread 7 is of the sort into which a standard tripod screw can be screwed. Because the internal thread 7 passes all the way through the adapter body 2, a tripod screw can be screwed into the internal thread 7 from either side.

The thread longitudinal axis of the internal thread 7 and the screw thread axis of the tripod screw 4 extend parallel to one another. In addition, it can be seen that the connecting portions 3 and 6 or the connecting means arranged thereon (tripod screw 4 and internal thread 7) are offset both in a direction parallel to the screw thread axis of the tripod screw 4 and in a direction perpendicular thereto. This offset is achieved here by means of the S-shape of the adapter body 2.

The depicted connection adapter 1 is now fixed for use in the manner depicted in FIG. 3 in a tripod threaded bush B which is introduced on a central axis A of binoculars F in the longitudinal direction from a front side by means of screwing the tripod threaded screw 4 into same. The rubber washer 5, which is compressed when screwing the threaded screw 4 into the tripod threaded bush B, ensures a pressure directed against the screwing direction, which locks the thread of the threaded screw 4 in the tripod threaded bush B and prevents unintentional detachment. In order to be able to better manipulate the tripod threaded screw 4, it has a knurled edge on its screw head. In addition, as depicted in FIG. 3, slit-shaped recesses in a cross shape, for example, can be provided in the screw head, which a coin or a similar tool for example can engage in in order to thus allow tightening or loosening of the tripod threaded screw 4 with the aid of such an implement. Such tool approaches can naturally also assume other forms, such as that of a simple slit, or that of an approach for conventional tools, such as flat blade screwdrivers and Phillips screwdrivers, Allen keys and other similar tools. In particular when it is provided that the tripod threaded screw is to be fixed by means of a tool, it is also possible to dispense with a knurling of the edge of the screw head of the sort depicted in the figure.

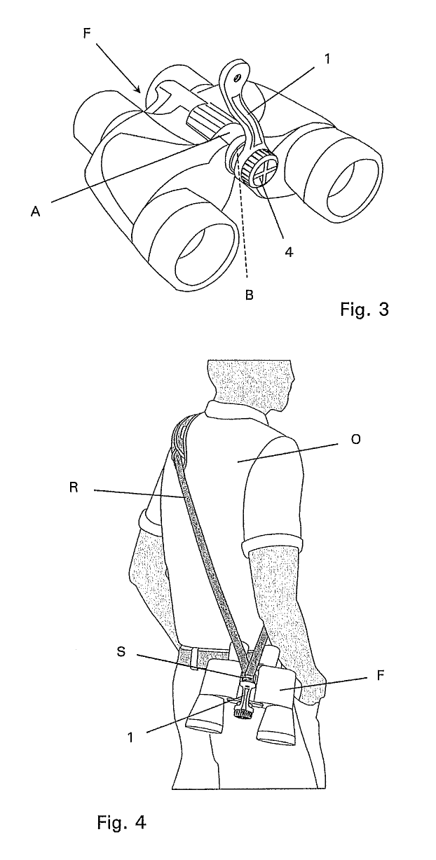

FIG. 4 then shows how the connection adapter 1 fixed to the binoculars F as depicted in FIG. 3 is fixed to a connection piece, here a tripod screw S, of a carrying strap R, which is guided crosswise over the upper body O of a wearer. In this way, the binoculars F can, as depicted in FIG. 4, be comfortably worn and carried at the hip level of the wearer. Because the connection piece in the form of the tripod screw S can be guided in a sliding manner over the carrying strap R with a bracket eyelet, the binoculars can be easily taken from the position depicted in FIG. 4 by means of grasping them with one hand and then brought in front of the face in order to then be able to view a desired object through the binoculars.

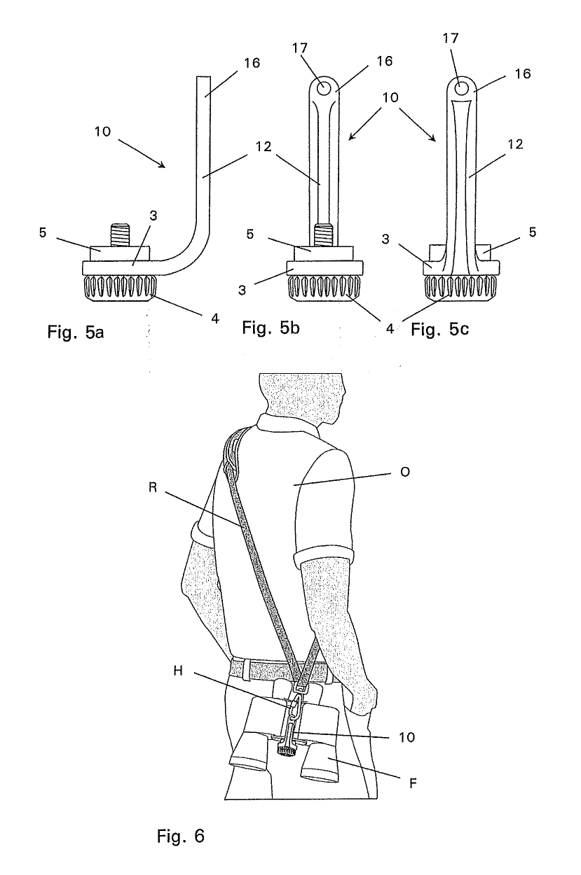

FIGS. 5 a) to c) and 6 depict a second exemplary embodiment of a connection adapter according to the invention which is identified therein with the reference numeral 10. The connection adapter 10 also has an adapter body 12, which is provided with a first connecting portion 3 which is substantially formed identical to the first connecting portion 3 of the connection adapter 1 according to the first exemplary embodiment. Here too, a tripod screw 4 is fed through an opening and undetachably secured with a rubber washer 5 fed over the thread of the tripod screw 4. However, by way of a departure from the previously depicted exemplary embodiment, according to this exemplary embodiment, the shape of the adapter body 12 of the connection adapter 10, which is likewise formed flat and band-shaped here, is not S-shaped, but rather L-shaped. A connecting portion 16 is situated on one longitudinal end of the adapter body 12 opposite the connecting portion 3, in which connecting portion a coupling element, in this case an eyelet 17 in the form of a simple bore through the adapter body 12, is formed. This eye 17 serves for connection of the connection adapter 10 to an alternative connection piece of a carrying strap, as is seen in particular from FIG. 6. This shows, in a depiction comparable to FIG. 4, how the connection adapter 10, which is connected in the same way via the tripod screw 4 to the threaded bush of the binoculars F, is connected to another connection piece, which here has the form of a spring hook H, of a carrying strap R. The carrying strap R depicted here is likewise worn crosswise over the upper body O of a user. The spring hook H is, as FIG. 6 shows, fed through the eyelet 17 and closed and secured. The connection adapter 10 is thus connected to the carrying strap R in this way here. The binoculars F are again carried in the manner as described above with reference to FIG. 4 and can in the same way be quickly raised to the face ready for use when wanting to view an object through the binoculars. It is of course evident that another form of coupling element, e.g. a ball coupler, a snap connector, or the like can be provided instead of the eyelet 17 in the connecting portion 16.

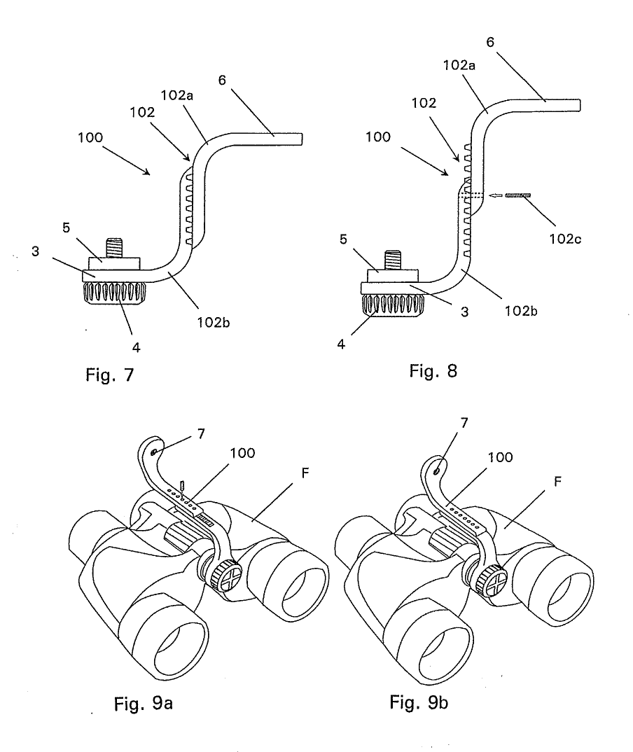

A third exemplary embodiment of a connection adapter according to the invention is depicted in FIGS. 7, 8 and 9 a) and b). The exemplary embodiment of a connection adapter depicted therein, which is identified in the figures with the reference numeral 100, in principle corresponds to the connection adapter according to the first exemplary embodiment depicted in FIGS. 1 to 4. Here too, an adapter body 102 is provided, which extends curved in an S-shape, having a first connecting portion 3 and a second connecting portion 6, which extend plateau-like flat and parallel to one another in their orientation, but offset from one another. In the first connecting portion 3, a tripod screw 4 is again undetachably fixed by feeding it through a bore in the adapter body 102 and securing it with a rubber washer 5. In the second connecting portion 6, there is (not perceptible in FIGS. 7 and 8, but visible in FIGS. 9 a) and b)) an internal thread 7 formed in the same way as in the exemplary embodiment according to FIGS. 1 to FIG. 4. The special and, compared with the first exemplary embodiment, different feature of the connection adapter 100 according to the third exemplary embodiment is that its adapter body 102 is not formed integral, but is instead divided into two partial bodies 102a and 102b, which can be detachably connected to one another in different positions, as comparison between FIGS. 7 and 8 indicates. A ratchet-style structuring not only permits the creation of distinct positions, in which the two partial bodies 102a and 102b can be connected to one another, this structuring also produces a form locking in the connected state. For the connection of the two partial bodies 102a and 100b, a set screw 102c, for example, is inserted, which can be screwed into internal threads provided at different positions in the partial body 102b. By means of the connection adapter 100, it is thus possible to realize an adjustment of the spacing between the two connecting portions 3 and 6 in a direction parallel to the screw thread axis of the tripod screw 4 in order to be able to individually adjust this spacing to the shape of the binoculars F to be attached with the connection adapter 100 to a carrying strap so as to thus set an optimal attachment point for the binoculars F. This possibility is again graphically depicted in FIGS. 9a) and b), which show the connection adapter 100 in a fixation to binoculars F as already described previously with reference to FIG. 3 with differently set spacing of the connecting portions 3 and 6. It should be clarified that the possibility of a length adjustment of the adapter body 102 with two partial bodies can also be achieved in other ways than by means of a fixation using the set screw 102c. It is thus possible to provide a latching mechanism, or it is also possible for a (one-off or repeated) setting and fixing to occur by means of e.g. deformation of a portion of in any case one of the partial bodies 102a, b, or the like.

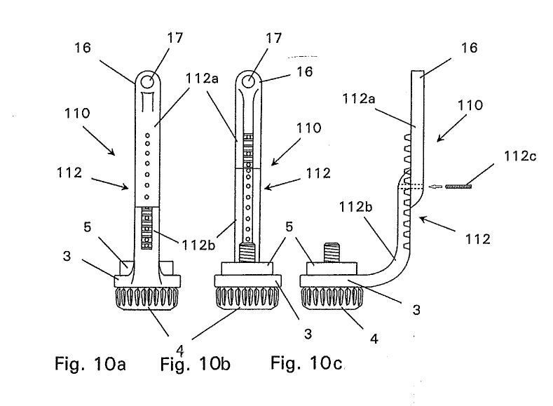

FIGS. 10a, 10b and 10c finally depict a fourth exemplary embodiment of the invention. The connection adapter 110 depicted there substantially corresponds to the connection adapter according to the second exemplary embodiment, in other words, the connection adapter 10 depicted in FIGS. 5a) to c) and 6. Here again, the connection adapter 110 is essentially constructed in a similar way to the connection adapter 10 with a first connecting portion 3 and the tripod threaded screw 4 fixed thereto, which is undetachably secured with the rubber washer 5, and the second connecting portion 16 formed on another longitudinal end of the L-shape formed adapter body 112 with the coupling element, here again in the form of an eyelet 17 formed therein. Here too, like in the above described third exemplary embodiment, the adapter body 112 is now not formed integral, but is again formed from two partial bodies 112a and 112b, which can be connected to one another in different positions relative to one another, and once again secured with a set screw 112c. In this depicted exemplary embodiment too, the thus obtained adjustability serves for adjustment and adaptation of the attachment point for hanging on a carrying strap according to the shape and the type of the binoculars to be carried with the carrying strap.

The above description of the exemplary embodiments has further clarified the advantages and special features of the connection adapter according to the invention. In particular, it has thus been made clear that the connection adapter according to the invention essentially serves for retrofitting a carrying strap which is known per se for the transportation of cameras according to the design of WO 2008/131135 A1 for the purpose of also wearing and transporting binoculars. The different configuration and shape of the adapter body and of the second connecting portion (in one case with an internal thread 7 for a tripod screw and in one case with an eyelet 17) serve only to adapt the connection adapter, which is otherwise identically formed with regards to its design and its intended purpose or the technical effect, to the specifically formed connection piece of the carrying strap.

### LIST OF REFERENCE NUMERALS

1 connection adapter

2 adapter body

3 first connecting portion

4 tripod screw

5 rubber washer

6 second connecting portion

7 internal thread

10 connection adapter

12 adapter body

16 second connecting portion

17 eyelet

100 connection adapter

102 adapter body

102a, b partial body

102c set screw

110 connection adapter

112 adapter body

112a, b partial body

112c set screw

A central axis

F binoculars

H spring hook

O upper body

R carrying strap

S tripod screw

1. A connection adapter for connecting a carrying strap to binoculars comprising:
an adapter body, which has:
a first connecting portion in which a tripod screw for connection to a tripod bush is arranged rotatably relative to the adapter body and oriented with a screw thread axis along a first direction; and
a second connecting portion with means for connection to a connection piece arranged on the carrying strap;
wherein the first and second connecting portions are offset relative to one another in a direction perpendicular to the screw thread axis by a first spacing and in a direction parallel to the screw thread axis by a second spacing; and wherein:
i. the second connecting portion has an internal thread for receiving a tripod screw formed with a thread axis extending parallel to the screw thread axis or inclined relative thereto by a maximum of 20°, or
ii. the second connecting portion has a coupling element.

2. The connection adapter according to claim 1, wherein the adapter body is formed from at least two partial bodies, wherein a first one of the at least two partial bodies carries the first connecting portion and a second of the at least two partial bodies carries the second connecting portion, wherein the at least two partial bodies are connectable to one another in at least two different positions in order to variably adjust at least one of the first spacing or the second spacing.

3. The connection adapter according to claim 1, wherein the adapter body is entirely integrally formed.

4. The connection adapter according to claim 1, wherein the first connecting portion is arranged in a first flat plateau region and that the second connecting portion is arranged in a second flat plateau region, wherein the first and second flat plateau regions are oriented substantially parallel to one another in their respective flat extension.

5. The connection adapter according to claim 1, wherein a surface of the adapter body between the first and the second connecting portion has a course which is curved in an S shape in one cross section.

6. The connection adapter according to claim 1, wherein the adapter body is formed band-shaped and flat.

7. The connection adapter according to claim 1, wherein the adapter body is formed from a plastic.

8. The connection adapter according to claim 1, wherein the adapter body is formed from a metal.

9. The connection adapter according to claim 1 wherein the tripod screw in the first connecting portion is undetachably fixed to the adapter body.

10. The connection adapter according to claim 1 wherein the second connecting portion has the internal thread for receiving the tripod screw formed with the thread axis extending parallel to the screw thread axis or inclined relative thereto by the maximum of 20°; and wherein the internal thread in the second connecting portion is formed passing through the second connecting portion in such a way that the tripod screw is screwable into the internal thread from both open sides thereof.

11. The connection adapter according to claim 1, wherein the second connecting portion has a coupling element; and the coupling element is an eyelet.

12. The connection adapter according to claim 1 wherein the first spacing is from about 5 mm up to about 100 mm.

13. The connection adapter according to claim 1, wherein the second spacing is from about 10 mm up to about 500 mm.
